(19) United States
(12) Patent Application Publication
(10) Pub. No.: US 2005/0235102 A1
(43) Pub. Date: Oct. 20, 2005

(54) Memory controller, semiconductor integrated circuit device, microcomputer, and electronic equipment

(76) Inventor: Mikio Sakurai, Toukuba (JP)

Correspondence Address: HARNESS, DICKEY & PIERCE, P.L.C., P.O. BOX 828, BLOOMFIELD HILLS, MI, 48303, US

(21) Appl. No.: 11/100,230

(22) Filed: Apr. 6, 2005

(30) Foreign Application Priority Data
Apr. 20, 2004 (JP) 2004-124388

(51) Int. Cl. G06F 12/00

(52) U.S. Cl. 711/106

(57) ABSTRACT

An auto refresh control circuit of a memory controller comprises an auto refresh request generation circuit that generates auto refresh requests at the predetermined intervals, a hold count circuit that holds an auto refresh request to the dynamic random access memory in the state of being impossible to access a memory for auto-refreshing at the timing of generation of the auto refresh request and counts a number of holds, and a circuit that executes a held auto refresh request to the dynamic random access memory until the number of times of executing reaches the number of holds, when detecting the idle state. When the held auto refresh request is executed, the number of holds is updated based on the number of times the held auto refresh request is executed.

### RELATED APPLICATIONS

This application claims priority to Japanese Patent Application No. 2004-124388 filed Apr. 20, 2004 which is hereby expressly incorporated by reference herein in its entirety.

### BACKGROUND

1. Technical Field

The present invention relates to a memory controller, a semiconductor integrated circuit device, a microcomputer, and electronic equipment.

2. Related Art

When refreshing is executed for a SDRAM, either a method of waiting until the so called idle state, in which there is no read/write access to the SDRAM, or a method of interrupting a read/write access is adopted.

In the method of waiting until the idle state, there is a problem that if a new refresh request is generated in the state of waiting for refreshing of the SDRAM, the previous refresh request is cancelled and, as a result, refreshing is not executed the number of times specified for the SDRAM.

On the other hand, in the method of interrupting read/write from/to the SDRAM, there is a problem that a continuous access to the SDRAM is not secured in performing a critical process for the SDRAM.

The present invention addresses the above problems and is intended to provide a memory controller, a semiconductor integrated circuit device, a microcomputer, and electronic equipment that do not allow refreshing to be executed an insufficient number of times and can secure read/write from/to the SDRAM in performing a critical process.

### SUMMARY

The present invention is a memory controller, comprising an auto refresh control circuit that executes an auto refresh control on a dynamic random access memory, the auto refresh control circuit comprising: an auto refresh request generation circuit that generates an auto refresh request at a predetermined interval; a hold count circuit that holds an auto refresh request to the dynamic random access memory in a state of being impossible to access a memory for auto-refreshing at the timing of generation of the auto refresh request and counts a number of holds; and a circuit that executes a held auto refresh request to the dynamic random access memory until the number of times of executing reaches the number of holds, when a state becomes an idle state; when the held auto refresh request is executed, the hold count circuit updating the number of holds based on a number of times the held auto refresh request is executed.

The dynamic random access memory includes a DRAM and a synchronous DRAM (hereinafter, referred to as a SDRAM).

The SDRAM is a DRAM that is characterized in that an execution of read/write is synchronized with a clock. Operations of read/write from/to the DRAM and SDRAM are carried out by inputting commands.

The DRAM and SDRAM have, as their main states, the idle state, which is the state of waiting for input of a command from a host, the memory read/write state such as the read state, in which a command and an address are input and the data with an address subsequent to the input address is output to the host, and the write state, in which the input data is written at the address subsequent to the input address, and the auto refresh state, in which refreshing is executed at predetermined intervals.

In this case, a predetermined interval is, for example, 16 microseconds.

The auto refresh request generation circuit may measure a predetermined interval by using a counter (auto refresh interval measurement counter) or the like to generate pulses or the like for an auto refresh request at predetermined intervals.

If the dynamic random access memory is in the idle state at the timing of an auto refresh request, the auto refresh request can be executed to the dynamic random access memory.

In the present invention, generated auto refresh requests are held during memory read/write, and the number of held auto refresh requests is recorded, for example, in an auto refresh hold counter. At the point when the memory read/write request is completed and the state becomes the idle state, whether there are one or more holds of auto refresh requests is checked, and if the presence of one or more holds is found, auto-refreshing is executed the number of times corresponding to the holds.

The DRAM (dynamic access memory), as its characteristics, need execute refreshing the specified number of times within a given period. If this auto-refreshing is not executed, data stored in a memory is not secured, and may be lost.

In the conventional method of waiting until the idle state and executing an auto refresh request, there is a problem that if a new refresh request is generated in the state of waiting for refreshing, the previous refresh request is cancelled and refreshing is therefore not executed the number of times specified for the dynamic random access memory. According to the present invention, however, the number necessary for refreshing can be kept until refreshing is executed.

Refreshing the necessary number of times in the idle state do not allow refreshing to be executed an insufficient number of times and can secure read/write from/to the DRAM in performing a critical process.

In the memory controller of the present invention, the auto refresh control circuit comprising: a forced refresh execution timing detection circuit that compares the number of holds to a predetermined threshold set for forced-refreshing and detects forced refresh execution timing; and a forced auto refresh execution circuit that interrupts the state of being impossible to access the dynamic random access memory when forced refresh execution timing is generated and executes a held auto refresh request.

The forced refresh execution timing is, for example, the time at which the value of an auto refresh hold counter for counting the number of holds of auto refresh requests exceeds the threshold, or becomes more than the value of the threshold.

Upon detecting forced refresh execution timing, the forced refresh execution timing detection circuit may output, for example, forced refresh request signals (for example, making forced refresh request signals at H level).

The state of being impossible to access a dynamic random access memory means, for example, a break of memory access for read/write or the like in the case where access to the dynamic random access memory for read/write or the like is impossible.

When the forced refresh execution timing is generated, the forced auto refresh execution circuit interrupts an access request or the like currently during execution, which causes an obstruction to an auto refresh request, and forcibly executes the auto refresh request.

For example, in the case where a large number of masters alternately access a memory controller, it can be supposed that the state does not return to the idle state and memory read/write is continuously generated.

According to the present invention, however, if the number of holds exceeds a predetermined threshold set for a forced refresh, auto-refreshing has a priority even during the memory read/write (refreshing is forcibly executed). Namely, refreshing is forcibly executed in the case where auto-refreshing is inevitably necessary; the loss of data stored in the memory can thereby be avoided.

In the memory controller of the present invention, when an access request is generated during execution of two or more held auto refresh requests, the auto refresh control circuit interrupts a continuous auto refresh request.

In the present invention, when an access request is generated during execution of two or more continuous auto-refreshing, the auto-refreshing can be immediately interrupted to give priority to the access request.

Accordingly, when an access request is generated during execution of a plurality of held auto-refreshing, the delay in access can be prevented.

In the memory controller of the present invention, when access responding to the generated access request finishes and the state becomes the idle state, the auto refresh control circuit executes a held auto refresh request that has still not been executed due to interruption of a continuous auto refresh request.

According to the present invention, the auto refresh that is not executed (is held) due to interruption is executed at the point when the memory read/write request is completed and the memory controller becomes idle again.

The present invention is a semiconductor integrated circuit device comprising the memory controller according to any one of the above.

The present invention is a microcomputer comprising the memory controller according to any one of the above.

The present invention is electronic equipment comprising the microcomputer according to the above, an input means of data to be processed by the microcomputer, and an LCD output means for outputting data processed by the microcomputer.

### BRIEF DESCRIPTION OF THE DRAWINGS

FIG. 1 is a diagram for explaining a semiconductor integrated circuit device of the present embodiment.

FIG. 2 is a timing chart for explaining features of the present embodiment.

FIG. 3 is a diagram for explaining a first auto refresh control of the present embodiment.

FIG. 4 is a diagram for explaining a second auto refresh control of the present embodiment.

FIG. 5 is a diagram for explaining a third auto refresh control of the present embodiment.

FIG. 6 is an example of a hardware block diagram of a microcomputer of the present embodiment.

FIG. 7 is an example of a block diagram of electronic equipment of the present embodiment.

FIGS. 8A, 8B, and 8C are examples of outline views of variety types of electronic equipment.

### DETAILED DESCRIPTION

Memory Controller, Semiconductor Integrated Circuit Device

A preferred embodiment of the present invention will be described in detail below with reference to the drawings.

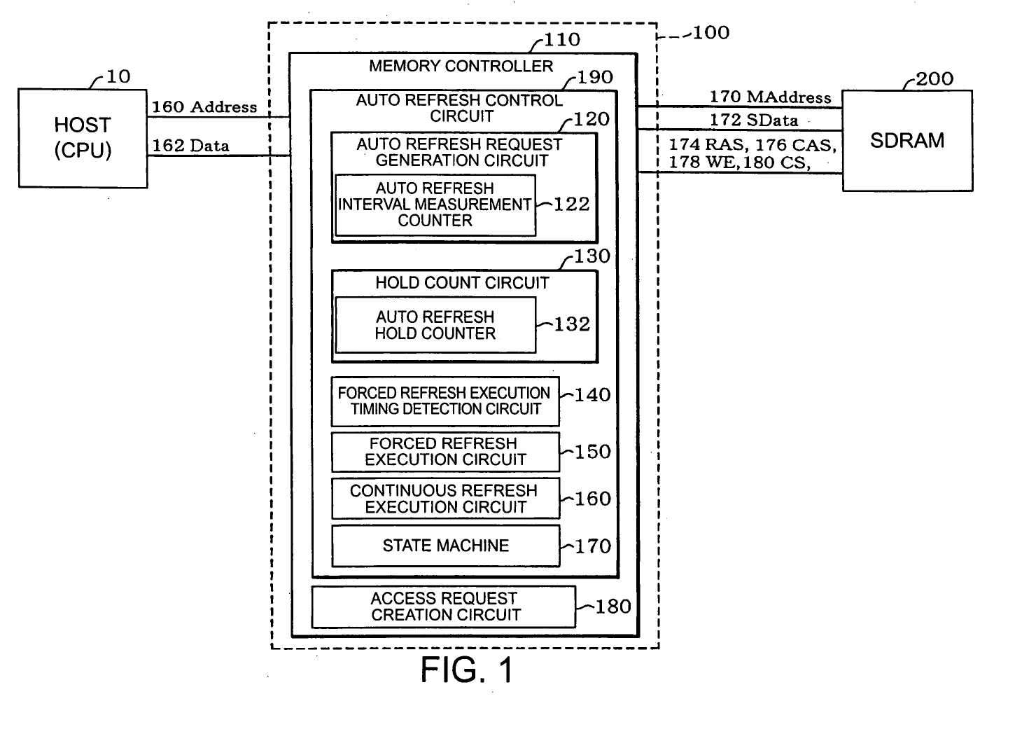

FIG. 1 is a diagram for explaining a memory controller and a semiconductor integrated circuit device of the present embodiment.

A memory controller 110 of the present embodiment comprises a memory controller 110 that outputs signals 170, 172, 174, 176, and 178 to control access to a SDRAM 200 based on access requests 160 and 162 from a host (CPU or DMA).

A semiconductor integrated circuit device 100 of the present embodiment includes the memory controller 110 of the present embodiment.

The memory controller 110 is connected to a host (CPU or DMA) 10 and the SDRAM 200, and includes an auto refresh control circuit 190 and an access request generation circuit 180.

The auto refresh control circuit 190 includes an auto refresh request generation circuit 120, a hold count circuit 130, a forced refresh execution timing detection circuit 140, a forced refresh execution circuit 150, a continuous refresh execution circuit 160, and a state machine 170.

The auto refresh request generation circuit 120, which includes an auto refresh interval measurement counter 122, measures a predetermined interval by using the auto refresh interval measurement counter 122 and generates auto refresh requests at predetermined intervals.

The hold count circuit 130 includes an auto refresh hold counter 132. When the state is not in the idle state at the timing of generating an auto refresh request, the auto refresh request to the dynamic random access memory is held and the auto refresh hold counter 132 counts and keeps the number of times the auto refresh request is held. When the held auto refresh request is executed, the number of holds is updated based on the number of times the held auto refresh request is executed.

When detecting the idle state, the continuous refresh execution circuit 160 executes a held auto refresh request to the dynamic random access memory until the number of times of executing reaches the number of holds.

The forced refresh execution timing detection circuit 140 compares the number of holds to a predetermined threshold that is set for forced-refreshing, and detects the forced refresh execution timing.

When the forced refresh execution timing is generated, the forced refresh execution circuit 150 interrupts the state of being impossible to access the dynamic random access memory, and executes the auto refresh request that has been held.

The state machine 170 is hardware that shifts its state in accordance with an access request from the host and the state of the SDRAM 200.

The continuous refresh execution circuit 160 and the forced refresh execution circuit 150 may interrupt a continuous auto refresh request when an access request is generated during execution of two or more held auto refresh requests.

When the access responding to the generated access request finishes and the state becomes the idle state, the continuous refresh execution circuit 160 may execute the held auto refresh request that has still not been executed due to interruption of a continuous auto refresh request.

The access request generation circuit 180 generates and outputs signals 170, 172, 174, 176, and 178 to control access to the SDRAM 200 based on access requests 160 and 162 from a host (CPU or DMA) 10 and shift of the state of the state machine 170.

In the SDRAM 200, for example, a large number of memory cells are placed in vertical and horizontal directions and memory elements are provided at intersections of horizontal (row) direction lines and vertical (column) direction lines. The horizontal (row) direction line is a word line, which is selected by the row address strobe (RAS) 174. The vertical (column) direction line is a data line, which is designated by the column address strobe (CAS) 176. The write enable signals (WE signals) 178 are designation signals in writing the data (SDATA) 172, which is output from the memory controller 110, to the SDRAM 200, whereby the data is written at the address selected by the RAS 174 and CAS 176. Incidentally, the SDRAM 200 comprises, for example, a plurality of memories and a memory is selected by chip select signals (CS signals) 180.

The memory controller 110 creates the RAS 174 and CAS 176 according to address signals (Address) 160 supplied from the host (CPU or DMA) 10. The memory controller 110 also writes data (Data) 162 output from the host (CPU or DMA) 10 at the address designated by the RAS or CAS.

For example, when a read access request is output from the host (CPU or DMA) 10, the memory controller 110 prepares for data reading (read processing) according to the address signals (Address) 160. The memory controller 110 outputs the RAS 174 in synchronization with the CS signals 176 (activating the RAS), and subsequently outputs the CAS 176 to read the data from the corresponding address of the SDRAM 200. Then the memory controller 110 outputs the RAS 174 and WE signals 178 to perform precharge.

When a write access request is output from the host (CPU or DMA) 10, as the above, the memory controller 110 prepares for data writing (write processing), outputs the RAS 174 in synchronization with the CS signals 180 (activating the RAS), and subsequently outputs the CAS 176 and WE signals 178 to read the data from the corresponding address of the SDRAM 200. Then, as the above, the memory controller 110 outputs the RAS and WE signals 178 to perform precharge.

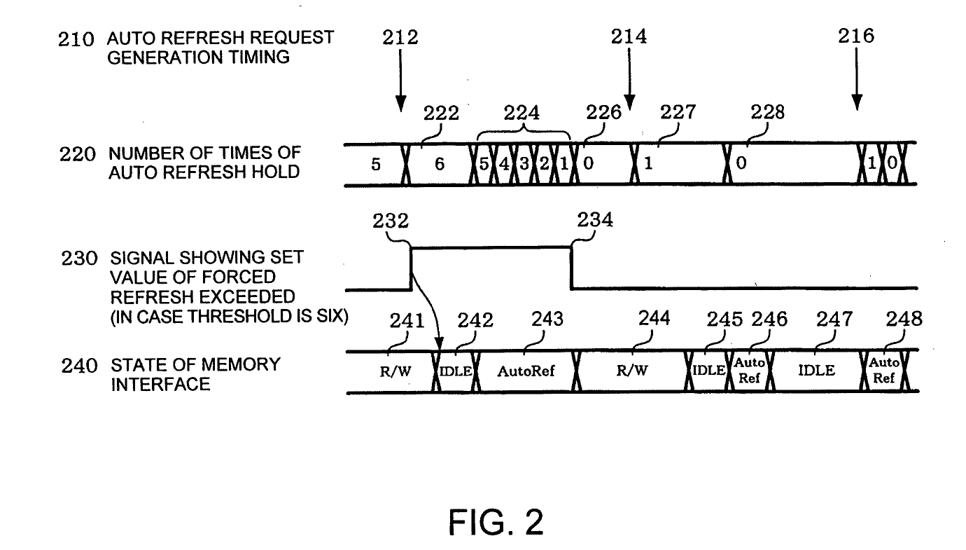

FIG. 2 is a timing chart for explaining features of the present embodiment.

The case in which an auto refresh request is held a plurality of times and then auto-refreshing is forcibly executed will be described.

210 indicates auto refresh request generation timing, and auto refresh requests 212,214, and 216 are generated at predetermined intervals.

220 indicates the number of times of auto refresh holds that is kept by the auto refresh hold counter. The number is incremented for each hold of a generated auto refresh request, and is decremented for each execution of a held auto refresh request.

230 indicates forced refresh signals showing that the set value of a forced refresh (a predetermined threshold set for a forced refresh, which is set to be six in this case) is exceeded. When the number of times of auto refresh holds 220 kept by the auto refresh hold counter exceeds the set value of forced-refreshing, the forced refresh signals change from a first level (for example, L level) to a second level (for example, H level).

240 indicates the state of the memory interface.

When an auto refresh request is generated at the timing of 212, the memory controller is in the read/write (R/W) state (241); the auto refresh request is held and the number of times of auto refresh hold 220 increments from 5 to 6 (refer to 222).

This means that the number of times of auto refresh holds 220 exceeds the set value of a forced refresh, 6, and the forced refresh signals change from the first level (for example, L level) to the second level (for example, H level) (refer to 232).

By changing the forced refresh signals to the second level (for example, H level), the R/W request (241) is interrupted, and after the state once becomes the idle state (242), auto-refreshing begins (243).

At this point, auto-refreshing for six times that has been held is executed; the value of the auto refresh hold counter is decremented as one auto-refreshing is completed (refer to 224).

The forced refresh signals that once became the second level (for example, H level) change to the first level (for example, L level) (refer to 234).

For example, in the case of an access request being generated during execution of two or more held auto refresh requests, if a continuous auto refresh request is interrupted and the access request corresponding to the generated access request is executed, the forced refresh signals may be left as being at the second level (H level) Thus, when the access corresponding to the generated access request is completed and the state becomes the idle state, reference to the forced refresh signals is made, and if the forced refresh signals are at the second level (H level), a held auto refresh request is executed again. As a result, the held auto refresh request, which has still not been executed due to interruption of a continuous auto refresh request, can be completed.

When an auto refresh request is generated at the timing of 214, the memory controller is in the R/W state (244); the auto refresh request is held and the number of times of auto refresh hold 220 increments from 0 to 1 (refer to 227).

When the R/W (244) is completed and the state returns to the idle state (245), a held auto refresh request (246) is executed to the dynamic random access memory until the number of times of execution reaches the number of holds, resulting in decrement of the number of holds (refer to 228).

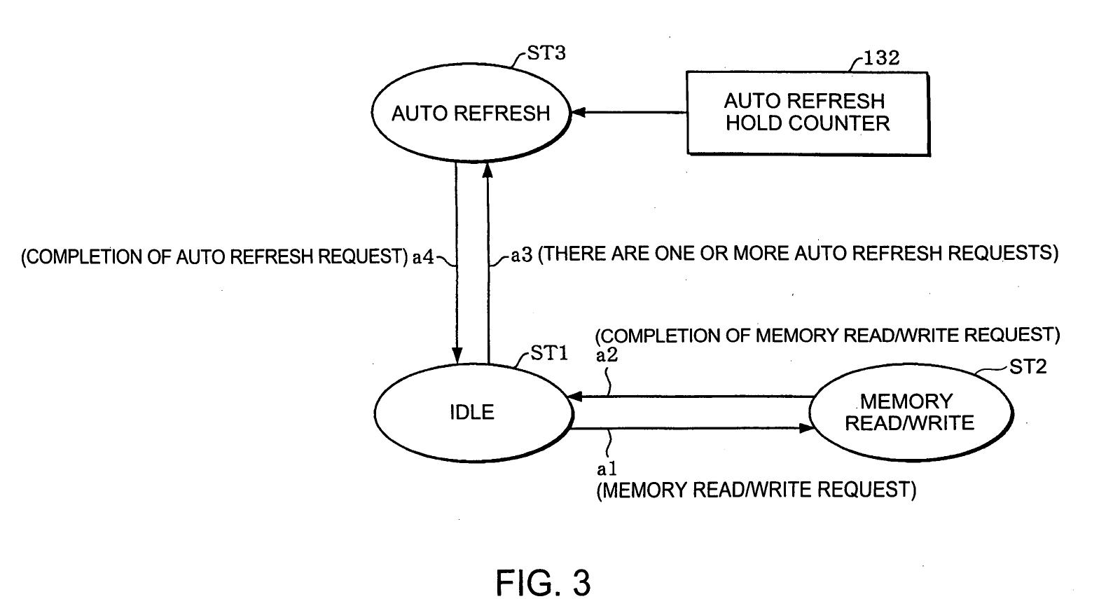

FIG. 3 is a diagram for explaining a first auto refresh control of the present embodiment.

In the first auto refresh control, a refresh request is held until the memory access becomes the idle state.

After the memory controller initializes the SDRAM, the SDRAM can be in three states, the idle state, the auto refresh state, and the read/write state.

In the present embodiment, a state machine of the memory controller stores the above states of the SDRAM as three states, idle (ST1), auto refresh (ST3), and memory read/write (ST2).

The timing of auto-refreshing is counted by the auto refresh interval measurement counter; a request of auto-refreshing is generated in a specific cycle. The memory controller holds auto-refreshing during memory read/write and records the number of holds of auto-refreshing in the auto refresh hold counter 132.

In the idle (ST1) state of the state machine, when a memory read/write request (a1) from the CPU is generated, read/write is requested to the SDRAM and the state of the state machine shifts to the memory read/write (ST2).

When completion of a memory read/write request (a2) is detected, the state of the state machine shifts to the idle (ST1).

In the idle (ST1) of the state machine, when there are one or more auto refresh requests (for example, the value of the auto refresh hold counter is one or more) (a3), the state of the state machine shifts to the auto refresh (ST3) and auto-refreshing is executed the number of times of holds, which is kept in the auto refresh hold counter.

When completion of an auto refresh request of the SDRAM (a4) is detected, the state of the state machine shifts to the idle (ST1).

Thus in the present embodiment, the generated auto refresh request is held until the memory read/write request is completed and the state becomes the idle (ST1), whether there are one or more auto refresh requests is checked at the point when the state becomes the idle (ST1), and if the presence of one or more auto refresh requests is found, the state shifts to the auto refresh (ST3). Auto-refreshing is executed the number of times of holds, which is kept in the auto refresh hold counter, and then the state returns to the idle (ST1).

According to the present embodiment, there is therefore no interruption caused by refreshing during continuous access. The number of necessary refreshing can be kept until refreshing is executed.

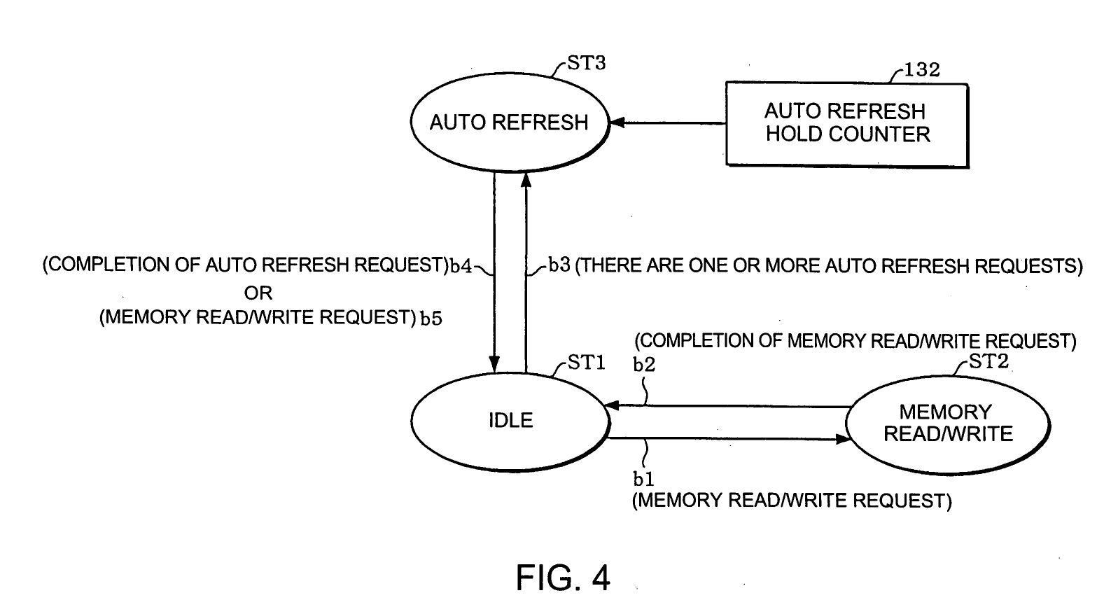

FIG. 4 is a diagram for explaining a second auto refresh control of the present embodiment.

In the second auto refresh control, a refresh request is held until the memory becomes the idle state, and when a memory read/write request is generated during execution of auto-refreshing, the auto-refreshing is immediately interrupted to give priority to the read/write of the memory.

After the memory controller initializes the SDRAM, the SDRAM can be in three states, the idle state, the auto refresh state, and the read/write state.

In the present embodiment, the state machine of the memory controller stores the above states of the SDRAM as three states, idle (ST1), auto refresh (ST3), and memory read/write (ST2).

The timing of auto-refreshing is counted by the auto refresh interval measurement counter; a request of auto-refreshing is generated in a specific cycle. The memory controller holds auto-refreshing during memory read/write and records the number of holds of auto-refreshing in the auto refresh hold counter 132.

In the idle (ST1) state of the state machine, when a memory read/write request (b1) from the CPU is generated, the read/write is requested to the SDRAM and the state of the state machine shifts to the memory read/write (ST2).

When completion of a memory read/write request (b2) is detected, the state of the state machine shifts to the idle (ST1).

In the idle (ST1) state of the state machine, when there are one or more auto refresh requests (for example, the value of the auto refresh hold counter is one or more) (b3), the state of the state machine shifts to the auto refresh (ST3) and auto-refreshing is executed the number of times of holds recorded in the auto refresh hold counter.

When a memory read/write request is generated during execution of auto-refreshing, the auto refresh is immediately interrupted, the state of the state machine shifts to the idle (ST1) to give priority to the read/write of the memory, read/write is requested to the SDRAM, and the state of the state machine shifts to the memory read/write (ST2).

When completion of an auto refresh request of the SDRAM (b4) is detected without generation of memory read/write request from the CPU during auto-refreshing, the state of the state machine shifts to the idle (ST1).

Thus in the present embodiment, the generated auto refresh request is held until the memory read/write request is completed and the state becomes the idle (ST1), whether there are one or more auto refresh requests is checked at the point when the state becomes the idle (ST1), and if the presence of one or more auto refresh requests is found, the state moves to the auto refresh (ST3). Refreshing is then executed the number of times of holds of auto-refreshing, which is kept in the auto refresh hold counter.

If memory read/write is generated during this period, however, the auto-refreshing is interrupted immediately to give priority to the memory read/write.

As a result, when an access request is generated from the CPU during execution of a plurality of auto-refreshing, the delay in processing can be prevented.

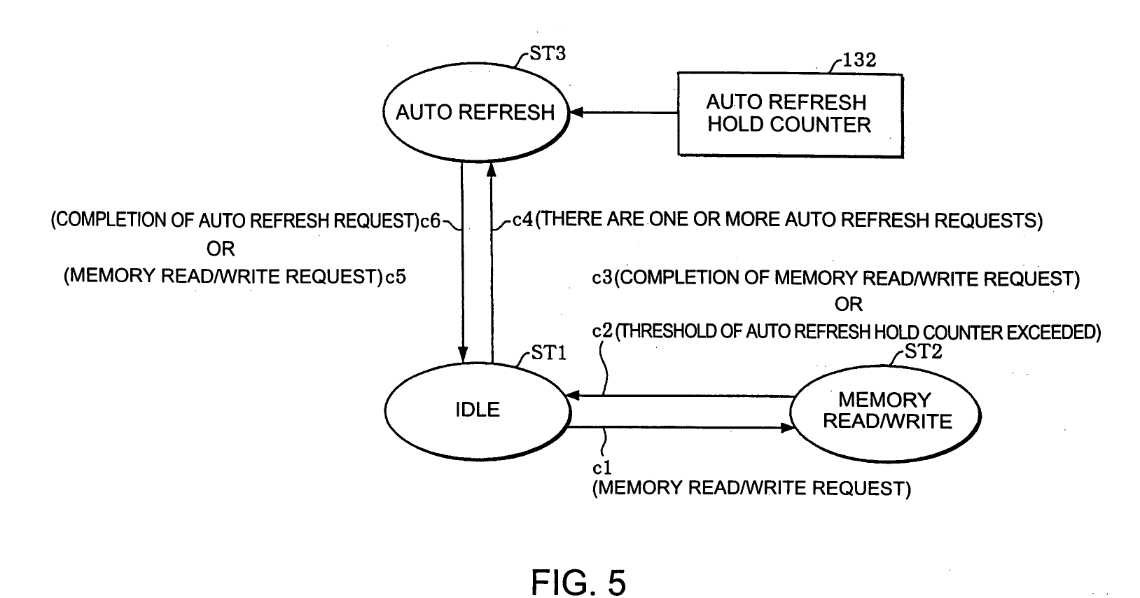

FIG. 5 is a diagram for explaining a third auto refresh control of the present embodiment.

In the third auto refresh control, a refresh request is held until the memory becomes the idle state, and when a memory read/write request is generated during execution of auto-refreshing, the auto-refreshing is immediately interrupted to give priority to the read/write of the memory. Even during the read/write of the memory, however, if the number of holds of auto-refreshing exceeds the set value, auto-refreshing is forcibly executed.

After the memory controller initializes the SDRAM, the SDRAM can be in three states, the idle state, the auto refresh state, and the read/write state.

In the present embodiment, the state machine of the memory controller stores the above states of the SDRAM as three states, idle (ST1), auto refresh (ST3), and memory read/write (ST2).

The timing of auto-refreshing is counted by the auto refresh interval measurement counter; a request of auto-refreshing is generated in a specific cycle. The memory controller holds auto-refreshing during memory read/write and records the number of holds of auto-refreshing in the auto refresh hold counter 132.

In the idle (ST1) state of the state machine, when a memory read/write request (c1) from the CPU is generated, the read/write is requested to the SDRAM and the state of the state machine shifts to the memory read/write (ST2).

When completion of a memory read/write request (c3) is detected, the state of the state machine shifts to the idle (ST1).

When the number of holds exceeding threshold (a predetermined set value) of the auto refresh hold counter is detected during read/write of the memory (c2), the state also shifts to the idle (ST1), and further to the auto refresh (ST3).

In the idle (ST1) state of the state machine, when there are one or more auto refresh requests (for example, the value of the auto refresh hold counter is one or more) (c4), the state of the state machine shifts to the auto refresh (ST3) and auto-refreshing is executed the number of times of holds of auto-refreshing, which is kept in the auto refresh hold counter.

When a memory read/write request (c5) is generated during auto-refreshing, the auto-refreshing is immediately interrupted, the state of the state machine shifts to the idle (ST1) to give priority to the read/write of the memory, the read/write is requested to the SDRAM, and the state of the state machine shifts to the memory read/write (ST2).

When completion of an auto refresh request of the SDRAM (c6) is detected without generation of a memory read/write request (c5) from the CPU during auto-refreshing, the state of the state machine shifts to the idle (ST1).

Thus in the present embodiment, the generated auto refresh request is held until the memory read/write request is completed and the state becomes the idle (ST1), whether there are one or more auto refresh requests is checked at the point when the state becomes the idle (ST1), and if the presence of one or more auto refresh requests is found, the state shifts to the auto refresh (ST3). Refreshing is then executed the number of times of holds of auto-refreshing, which is kept in the auto refresh hold counter.

If memory read/write is generated during this period, however, the auto refresh is interrupted immediately to give priority to the memory read/write.

As a result, when an access request is generated from the CPU during execution of a plurality of auto-refreshing, the delay in processing can be prevented.

Even during the read/write of the memory, if the number of holds of auto-refreshing exceeds the set value, auto-refreshing is forcibly executed.

A dynamic memory, as its characteristics, need execute refreshing the specified number of times within “a given period”. If this auto-refreshing is not executed, data stored in the memory is not secured, and may therefore be lost. For example, in the case where a large number of masters alternately access a memory controller, it can be supposed that the state does not return to the idle state and memory read/write is continuously generated.

Even in such a case, auto-refreshing is forcibly executed in the present embodiment if the number of holds of auto-refreshing exceeds the set value. As a result, data stored in the memory can be secured.

Microcomputer

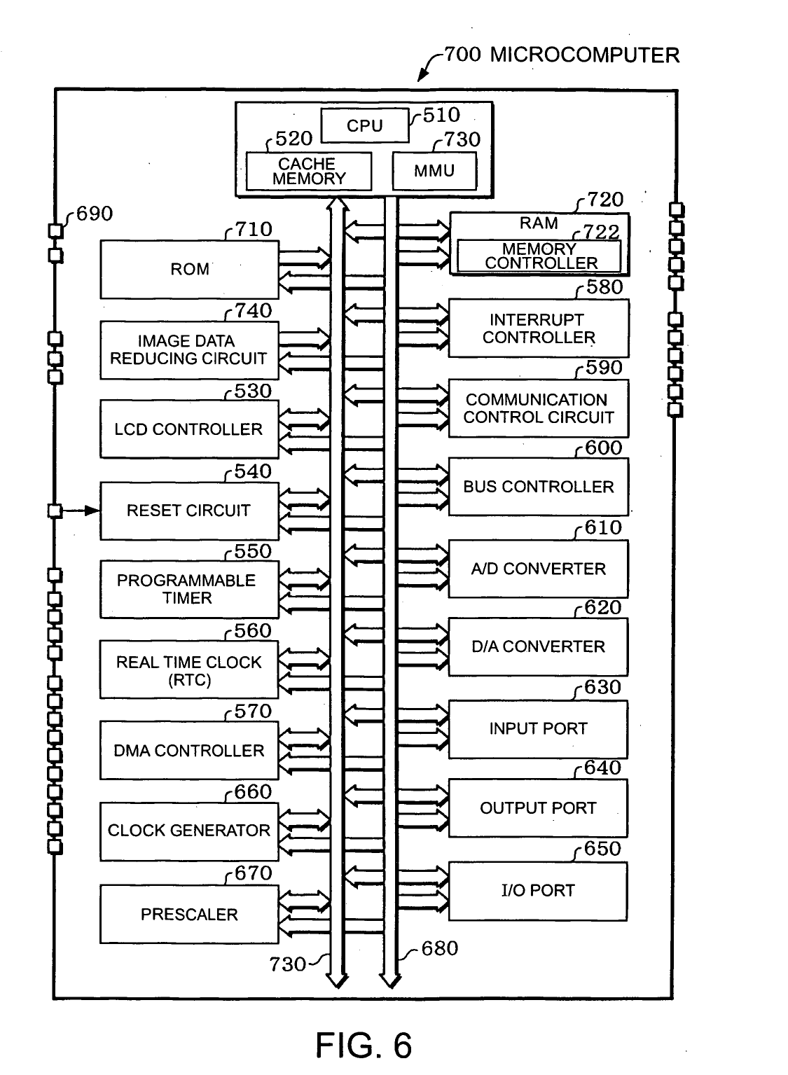

FIG. 6 is an example of a hardware block diagram of a microcomputer of the present embodiment.

This microcomputer 700 includes a CPU 510, a cache memory 520, an LCD controller 530, a reset circuit 540, a programmable timer 550, a real time clock (RTC) 660, a DRAM controllercum bus I/F 670, an interrupt controller 580, a serial interface 590, a bus controller 600, an A/D converter 610, a D/A converter 620, an input port 630, an output port 640, an I/O port 650, a clock generator 560, a prescaler 570, an MMU 730, an image process circuit 740, and a general purpose bus 680, a special purpose bus 730, and various types of pins 690 that connect these units, etc.

The RAM 720 includes a dynamic random access memory (DRAM or SDRAM) having a self-refresh function and a memory controller 722 of the present invention.

The memory controller 722 has, for example, a construction explained in FIG. 1.

Electronic Equipment

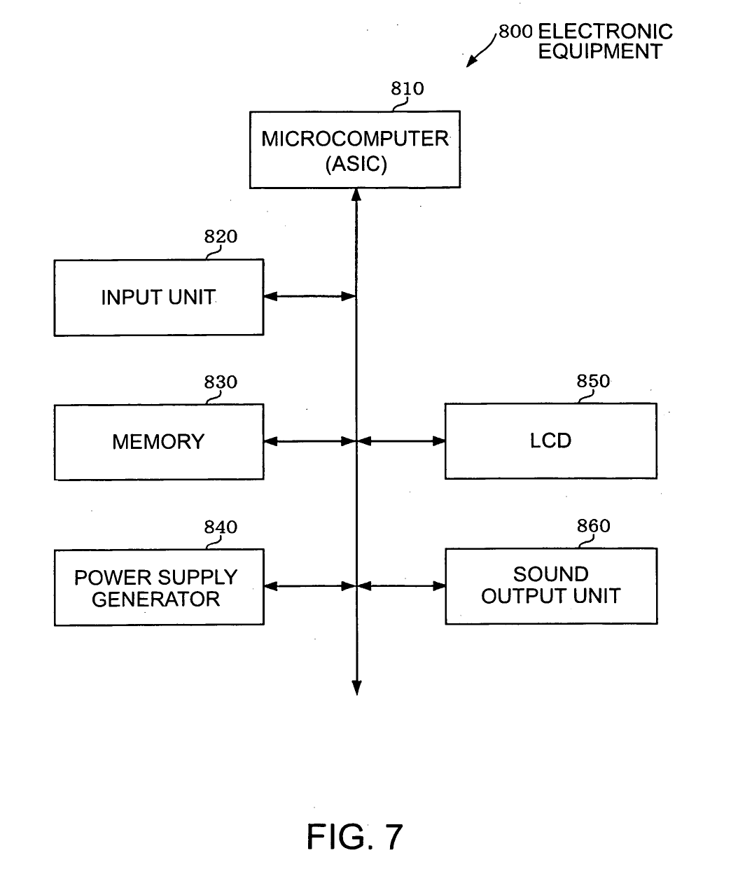

An example of a block diagram of electronic equipment of the present embodiment is shown in FIG. 7. This electronic equipment 800 includes a microcomputer (or ASIC) 810, an input unit 820, a memory 830, a power supply generator 840, an LCD 850, and a sound output unit 860.

In this equipment, the input unit 820 is a unit for inputting various types of data. The microcomputer 810 performs various types of processes based on data that are input by this input unit 820. The memory 830 becomes a work area of the microcomputer 810 or the like. The power supply generator 840 is a unit for generating various types of power supply used in the electronic equipment 800. The LCD 850 is a unit for outputting various types of images Getters, icons, and graphics) that the electronic equipment displays.

The sound output unit 860 is a unit for outputting various types of sound (voice, game music, or the like) and its function can be performed: by hardware such as a speaker.

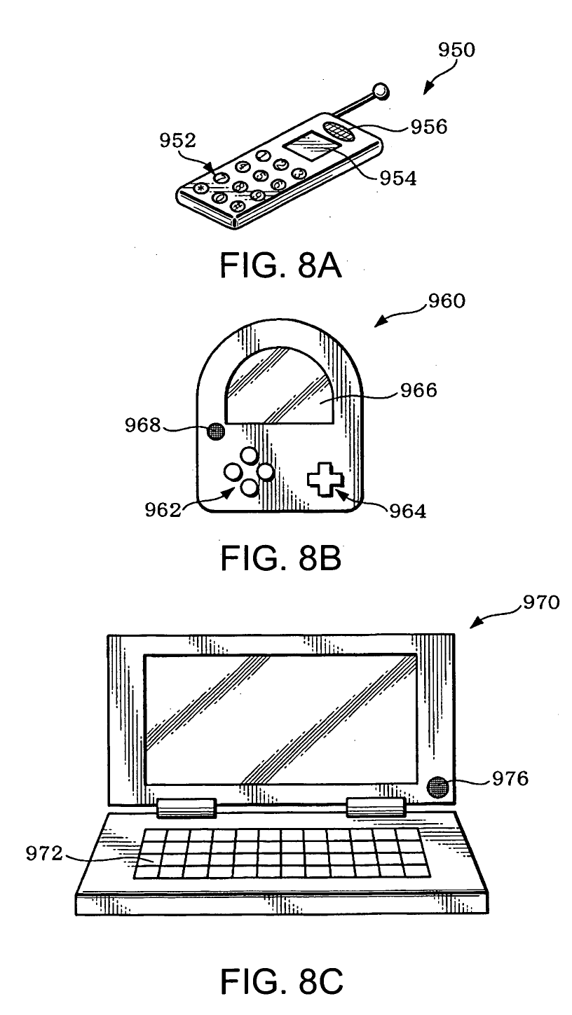

An example of an outline view of a cellular phone 950, one of electronic equipment, is shown in FIG. 8A This cellular phone 950 comprises dial buttons 952, which function as input units, an LCD 954, which displays telephone numbers, names, and icons, and a speaker, which functions as a sound output unit to output sound.

An example of an outline view of a portable game device 960, one of electronic equipment is shown in FIG. 8B. This portable game device 960 comprises manual operation buttons 962, which function as input units, a cross shape key 964, an LCD 966, which displays game images, and a speaker 968, which functions as a sound output unit to output game sound.

An example of an outline view of a personal computer 970, one of electronic equipment, is shown in FIG. 8C. This personal computer 970 comprises a keyboard 972, which functions as an input unit, an LCD 974, which displays letters, numerals, and graphics, and a sound output unit 976.

Incorporation of the microcomputer of the present embodiment into the electronic equipment of FIGS. 8A to 8C can provide low-cost electronic equipment having a small memory capacity.

Incidentally, electronic equipment that can utilize the present embodiment may be variety types of electronic equipment using an LCD such as a personal digital assistance, a pager, an electronic desk calculator, a device with a touch panel, a projector, a word processor, a view finder type or monitor direct view type video tape recorder, and a car navigation device other than the electronic equipment shown in FIGS. 8A, 8B, and 8C.

Incidentally, the present invention is not restricted to the present embodiment, but various modifications may be made in the scope of the present invention concepts.

1. A memory controller, comprising:
an auto refresh control circuit that executes an auto refresh control on a dynamic random access memory, the auto refresh control circuit including:
an auto refresh request generation circuit that generates an auto refresh request at a predetermined interval;
a hold count circuit that holds an auto refresh request to the dynamic random access memory in a state of being impossible to access a memory for auto-refreshing at timing of generation of the auto refresh request and counts holds; and
a circuit that executes a held auto refresh request to the dynamic random access memory until the number of times of executing reaches the number of holds, when a state becomes an idle state,
wherein when the held auto refresh request is executed, the hold count circuit updates the number of holds based on a number of times the held auto refresh request is executed.

2. The memory controller according to claim 1,
wherein the auto refresh control circuit further comprises:
a forced refresh execution timing detection circuit that compares the number of holds to a predetermined threshold set for a forced refresh and detects forced refresh execution timing; and
a forced auto refresh execution circuit that interrupts a state of being impossible to access the dynamic random access memory and executes a held auto refresh request when forced refresh execution timing is generated.

3. The memory controller according to claim 1,
wherein when an access request is generated during execution of two or more held auto refresh requests, the auto refresh control circuit interrupts a continuous auto refresh request.

4. The memory controller according to claim 3,
wherein when access responding to the generated access request finishes and a state becomes an idle state, the auto refresh control circuit executes a held auto refresh request that has still not been executed due to interruption of a continuous auto refresh request.

5. A semiconductor integrated circuit device, comprising the memory controller according to claim 1.

6. A microcomputer, comprising the memory controller according to claim 1.

7. Electronic equipment, comprising:
the microcomputer according to claim 6;
an input means of data to be processed by the microcomputer; and
an LCD output means for outputting data processed by the microcomputer.
